(19) United States
(12) Patent Application Publication
(10) Pub. No.: US 2023/0245339 A1
(43) Pub. Date: Aug. 3, 2023

(54) Method for Adjusting Three-Dimensional Pose, Electronic Device and Storage Medium

(71) Applicant: Beijing Baidu Netcom Science Technology Co., Ltd., Beijing (CN)

(72) Inventors: Guanying CHEN, Beijing (CN); Xiaoqing YE, Beijing (CN); Xiao TAN, Beijing (CN); Hao SUN, Beijing (CN)

(73) Assignee: Beijing Baidu Netcom Science Technology Co., Ltd., Beijing (CN)

(21) Appl. No.: 17/884,275

(22) Filed: Aug. 9, 2022

(30) Foreign Application Priority Data
Jan. 28, 2022 (CN) 202210108845.7

(51) Int. Cl. G06T 7/73; G06V 20/40; G06T 19/20

(52) U.S. Cl. CPC G06T 7/73; G06V 20/46; G06T 19/20; G06T 2207/20081; G06T 2219/2004

(57) ABSTRACT

Provided are a method for adjusting a three-dimensional pose, an electronic device, and a storage medium, relates to the field of artificial intelligence, and specifically to computer vision and deep learning technologies. A specific implementation solution includes acquiring a video currently recorded; estimating multiple two-dimensional key points of a virtual three-dimensional model and an initial three-dimensional pose based on multiple image frames; performing contact detection on a target part of the virtual three-dimensional model by using the multiple two-dimensional key points, to obtain a detection result; determining multiple target three-dimensional key points by means of the detection result and multiple initial three-dimensional key points corresponding to the initial three-dimensional pose; and adjusting the initial three-dimensional pose to a target three-dimensional pose by using the multiple initial three-dimensional key points and the multiple target three-dimensional key points.

### CROSS-REFERENCE TO RELATED APPLICATIONS

The present disclosure claims priority of Chinese Patent Application No. 202210108845.7, filed to China Patent Office on Jan. 28, 2022. Contents of the present disclosure are hereby incorporated by reference in entirety of the Chinese Patent Application.

### TECHNICAL FIELD

The present disclosure relates to the field of artificial intelligence, specifically to computer vision and deep learning technologies, may specifically be applied in three-dimensional vision and human driven scenes, and in particular, relates to a method for adjusting three-dimensional pose, an electronic device, and a storage medium.

### BACKGROUND OF THE INVENTION

In the field of artificial intelligence, at least one three-dimensional pose of a human body is often required to be acquired. Since a conventional method for estimating the three-dimensional pose of the human body needs to use a complex action capture device, such as an action capture suit and an optical trapping device. Therefore, a monocular video-based action capture technology with simple device requirements is widely applied. In view of this, those skilled in the art constantly experiment with various monocular video-based algorithms for estimating the three-dimensional pose of the human body.

In view of the above problems, no effective solution has been provided yet.

### SUMMARY OF THE INVENTION

At least some embodiments of the present disclosure provide a method for adjusting three-dimensional pose, an electronic device, and a storage medium, so as at least to partially solve the technical problem that an algorithm does not optimize a constraint model of a human foot grounding effect, resulting inaccurate estimation of the three-dimensional pose of a human body and obvious floating feeling of a human foot action in the related art.

In an embodiment of the present disclosure, a method for adjusting three-dimensional pose is provided, including: acquiring a video currently recorded, where the video includes multiple image frames, and a virtual three-dimensional model is displayed in each of the multiple image frames; estimating multiple two-dimensional key points of a virtual three-dimensional model and an initial three-dimensional pose based on multiple image frames; performing contact detection on a target part of the virtual three-dimensional model by using the multiple two-dimensional key points, to obtain a detection result, where the detection result is configured to indicate whether the target part is in contact with a target contact surface in three-dimensional space where the virtual three-dimensional model is located; determining multiple target three-dimensional key points by means of the detection result and multiple initial three-dimensional key points corresponding to the initial three-dimensional pose; and adjusting the initial three-dimensional pose to a target three-dimensional pose by using the multiple initial three-dimensional key points and the multiple target three-dimensional key points.

In another embodiment of the present disclosure, an electronic device is further provided. The electronic device includes at least one processor and a memory communicatively connected with the at least one processor. The memory is configured to store at least one instruction executable by the at least one processor. The at least one instruction is performed by the at least one processor, to cause the at least one processor to perform the method for adjusting the three-dimensional pose mentioned above.

In another embodiment of the present disclosure, a non-transitory computer-readable storage medium storing at least one computer instruction is further provided. The at least one computer instruction is used for a computer to perform the method for adjusting the three-dimensional pose mentioned above.

In the embodiments of the present disclosure, the video currently recorded is acquired. The video includes the multiple image frames, and the virtual three-dimensional model is displayed in each of the multiple image frames. The multiple two-dimensional key points of the virtual three-dimensional model and the initial three-dimensional pose are estimated based on the multiple acquired image frames. Contact detection is performed on the target part of the virtual three-dimensional model by using the multiple two-dimensional key points, to obtain the detection result. The detection result is configured to indicate whether the target part is in contact with a target contact surface in three-dimensional space where the virtual three-dimensional model is located. The multiple target three-dimensional key points are determined by means of the detection result and the multiple initial three-dimensional key points corresponding to the initial three-dimensional pose. The initial three-dimensional pose is adjusted to the target three-dimensional pose by using the multiple initial three-dimensional key points and the multiple target three-dimensional key points. Therefore, a purpose of improving a monocular video-based algorithm for estimating the three-dimensional pose of a human body can be achieved, and the technical effect of enhancing the stability of human foot actions by adding grounding constraints into the monocular video-based algorithm for estimating the three-dimensional pose of the human body can be realized, thereby solving the technical problem that an algorithm does not optimize a constraint model of a human foot grounding effect, resulting inaccurate estimation of the three-dimensional pose of a human body and obvious floating feeling of a human foot action in the related art.

It is to be understood that, the content described in this section is not intended to identify the key or important features of the embodiments of the present disclosure, nor is it intended to limit the scope of the present disclosure. Other features of the present disclosure will become easy to understand through the following description.

### BRIEF DESCRIPTION OF THE SEVERAL VIEWS OF THE DRAWINGS

Drawings are used for better understanding the solution, and are not intended to limit the present disclosure.

FIG. 1 is a block diagram of a hardware structure of a computer terminal (or a mobile device) configured to implement a method for adjusting a three-dimensional pose according to an embodiment of the present disclosure.

FIG. 2 is a flowchart of a method for adjusting a three-dimensional pose according to an embodiment of the present disclosure.

FIG. 3 is a schematic diagram showing a result of estimating a human foot action in a standing pose based on a method for adjusting a three-dimensional pose according to an optional embodiment of the present disclosure.

FIG. 4 is a schematic diagram showing a result of estimating a human foot action in a walking pose based on a method for adjusting a three-dimensional pose according to an optional embodiment of the present disclosure.

FIG. 5 is a structural block diagram of an apparatus for adjusting a three-dimensional pose according to an embodiment of the present disclosure.

### DETAILED DESCRIPTION OF THE INVENTION

Exemplary embodiments of the present disclosure are described in detail below with reference to the drawings, including various details of the embodiments of the present disclosure to facilitate understanding, and should be regarded as exemplary. Thus, those of ordinary skilled in the art shall understand that, variations and modifications can be made on the embodiments described herein, without departing from the scope and spirit of the present disclosure. Likewise, for clarity and conciseness, descriptions of well-known functions and structures are omitted in the following description.

It is to be noted that terms “first”, “second” and the like in the description, claims and the above mentioned drawings of the present disclosure are used for distinguishing similar objects rather than describing a specific sequence or a precedence order. It should be understood that the data applied in such a way may be exchanged where appropriate, in order that the embodiments of the present disclosure described here can be implemented in an order other than those illustrated or described herein. In addition, terms “include” and “have” and any variations thereof are intended to cover non-exclusive inclusions. For example, it is not limited for processes, methods, systems, products or devices containing a series of steps or units to clearly list those steps or units, and other steps or units which are not clearly listed or are inherent to these processes, methods, products or devices may be included instead.

In an existing solution, a monocular video-based algorithm for estimating the three-dimensional pose of the human body does not optimize a constraint model of a human foot grounding effect. That is, this monocular video-based algorithm is low in accuracy, which causes jittering of the three-dimensional pose of the human body estimated by the monocular video-based algorithm and obvious floating feeling of a human foot action.

At least some embodiments of the present disclosure provide a method for adjusting three-dimensional pose, an electronic device, and a storage medium, so as at least to partially solve the technical problem that an algorithm does not optimize a constraint model of a human foot grounding effect, resulting inaccurate estimation of the three-dimensional pose of a human body and obvious floating feeling of a human foot action in the related art.

An embodiment of the present invention provides a method for adjusting a three-dimensional pose. It is to be noted that the steps shown in the flow diagram of the accompanying drawings may be executed in a computer system, such as a set of computer-executable instructions, and although a logical sequence is shown in the flow diagram, in some cases, the steps shown or described may be executed in a different order than here.

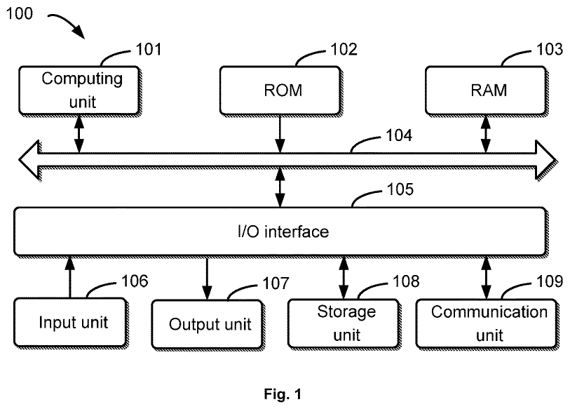

The method embodiment provided in the present disclosure may be performed in a mobile terminal, a computer terminal, or a similar electronic device. The electronic device is intended to represent various forms of digital computers, such as laptop computers, desktop computers, workbenches, personal digital assistants, servers, blade servers, mainframe computers, and other suitable computers. The electronic device may also express various forms of mobile devices, such as personal digital processing, cellular phones, smart phones, wearable devices, and other similar computing devices. The components shown herein, connections and relationships of the components, and functions of the components are examples, and are not intended to limit the implementation of the present disclosure described and/or required herein. FIG. 1 is a block diagram of a hardware structure of a computer terminal (or a mobile device) configured to implement a method for adjusting a three-dimensional pose according to an embodiment of the present disclosure.

As shown in FIG. 1, the computer terminal 100 includes a computing unit 101. The computing unit may perform various appropriate actions and processing operations according to a computer program stored in a Read-Only Memory (ROM) 102 or a computer program loaded from a storage unit 108 into a Random Access Memory (RAM) 103. In the RAM 103, various programs and data required for the operation of the computer terminal 100 may also be stored. The computing unit 101, the ROM 102, and the RAM 103 are connected with each other by using a bus 104. An Input/Output (I/O) interface 105 is also connected with the bus 104.

Multiple components in the computer terminal 100 are connected with the I/O interface 105, and include: an input unit 106, such as a keyboard and a mouse; an output unit 107, such as various types of displays and loudspeakers; the storage unit 108, such as a disk and an optical disc; and a communication unit 109, such as a network card, a modem, and a wireless communication transceiver. The communication unit 109 allows the computer terminal 100 to exchange information/data with other devices through a computer network, such as the Internet, and/or various telecommunication networks.

The computing unit 101 may be various general and/or special processing assemblies with processing and computing capabilities. Some examples of the computing unit 101 include, but are not limited to, a Central Processing Unit (CPU), a Graphics Processing Unit (GPU), various dedicated Artificial Intelligence (AI) computing chips, various computing units for running machine learning model algorithms, a Digital Signal Processor (DSP), and any appropriate processors, controllers, microcontrollers, and the like. The computing unit 101 performs the method for adjusting a three-dimensional pose described here. For example, in some embodiments, the method for adjusting a three-dimensional pose may be implemented as a computer software program, which is tangibly included in a machine-readable medium, such as the storage unit 108. In some embodiments, part or all of the computer programs may be loaded and/or installed on the computer terminal 100 via the ROM 102 and/or the communication unit 109. When the computer program is loaded into the RAM 103 and performed by the computing unit 101, at least one step of the method for adjusting a three-dimensional pose described here may be performed. Alternatively, in other embodiments, the computing unit 101 may be configured to perform the method for processing a video in any other suitable manners (for example, by means of firmware).

Various implementations of systems and technologies described here may be implemented in a digital electronic circuit system, an integrated circuit system, a Field Programmable Gate Array (FPGA), an Application-Specific Integrated Circuit (ASIC), an Application-Specific Standard Product (ASSP), a System-On-Chip (SOC), a Load Programmable Logic Device (CPLD), computer hardware, firmware, software, and/or a combination thereof. These various implementations may include: being implemented in at least one computer program, the at least one computer program may be performed and/or interpreted on a programmable system including at least one programmable processor. The programmable processor may be a dedicated or general programmable processor, which can receive data and instructions from a storage system, at least one input device, and at least one output device, and transmit the data and instructions to the storage system, the at least one input device, and the at least one output device.

It is noted herein that, in some optional embodiments, the electronic device shown in FIG. 1 may include a hardware element (including a circuit), a software element (including a computer code stored on the computer-readable medium), or a combination of the hardware element and the software element. It should be noted that, FIG. 1 is an example of a specific example, and is intended to illustrate the types of components that may be present in the above electronic device.

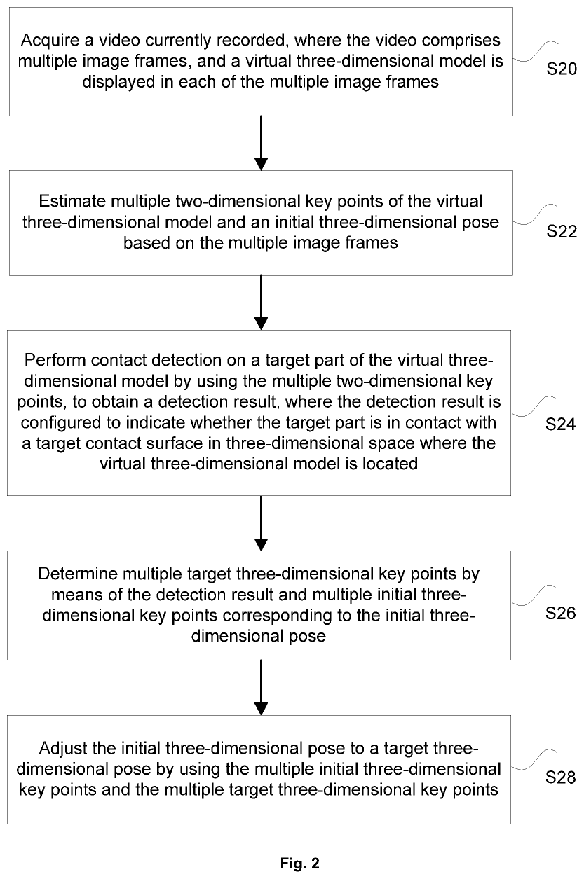

Under the above operation environment, the present disclosure provides the method for adjusting a three-dimensional pose shown in FIG. 2. The method may be performed by the computer terminal shown in FIG. 1 or a similar electronic device. FIG. 2 is a flowchart of a method for adjusting a three-dimensional pose according to an embodiment of the present disclosure. As shown in FIG. 2, the method may include the following steps.

At step S20, a video currently recorded is acquired. The video includes multiple image frames, and a virtual three-dimensional model is displayed in each of the multiple image frames.

The video currently recorded may be a monocular video recorded by a static camera. The video currently recorded may include the multiple image frames, and the virtual three-dimensional model is displayed in each image frame. The virtual three-dimensional model may be a virtual human body model. That is, the video currently recorded is a video that displays a movement state of the virtual human body model.

For example, a given monocular human movement video is recorded as Video1. The video includes T image frames, and the human body model is displayed in each image frame. According to this embodiment of the present disclosure, the Video1 may be estimated and optimized to adjust the stable three dimensional pose of the human body.

At step S22, multiple two-dimensional key points of the virtual three-dimensional model and an initial three-dimensional pose are estimated based on the multiple image frames.

The multiple two-dimensional key points may be points for research that are selected in the display area of the virtual three-dimensional model in the two-dimensional video. The multiple image frames in the video currently recorded are estimated to obtain the multiple two-dimensional key points of the virtual three-dimensional model and a three-dimensional pose of the virtual three-dimensional model. Then, the estimated three-dimensional pose of the model is regarded as the initial three-dimensional pose.

Still taking the adjustment of the three-dimensional pose of the human body based on Video1 as an example, the two-dimensional key point 2DP* of the virtual human body model in each of T image frames and the initial three-dimensional pose 3DS* may be estimated based on T image frames in Video1. The initial three-dimensional pose 3DS* may be represented by related pose parameters.

At step S24, contact detection is performed on a target part of the virtual three-dimensional model by using the multiple two-dimensional key points, to obtain a detection result. The detection result is configured to indicate whether the target part is in contact with a target contact surface in three-dimensional space where the virtual three-dimensional model is located.

The multiple two-dimensional key points may be points for research that are selected in the display area of the target part of the virtual three-dimensional model in the two-dimensional video. The multiple two-dimensional key points are used for performing contact detection on the target part of the virtual three-dimensional model to obtain the detection result. Contact detection is configured to detect the contact between the target part of the virtual three-dimensional model and the target contact surface of the three-dimensional space. The detection result is configured to indicate whether the target part is in contact with the target contact surface in three-dimensional space where the virtual three-dimensional model is located.

Still taking the adjustment of the three-dimensional pose of the human body based on Video1 as an example, toes and heels of left and right feet of the virtual human body model are selected as target parts. The target parts respectively correspond to four two-dimensional key points. That is, an A point corresponds to a left toe, a B point corresponds to a left heel, a C point corresponds to a right toe, and a D point corresponds to a right heel. A ground surface of the three-dimensional space where the virtual human body model is located is selected as the target contact surface. Through detecting position relationships between each of the A, B, C, D key points and the ground surface, whether the toes and heels of the left and right feet are in contact with the ground surface may be determined. Then, the contact between each of the toes and heels of the left and right feet and the ground surface is saved as the detection result, which is recorded as R{A, B, C, D}.

At step S26, multiple target three-dimensional key points are determined by means of the detection result and multiple initial three-dimensional key points corresponding to the initial three-dimensional pose.

The initial three-dimensional key points are multiple key points corresponding to the initial three-dimensional pose. Then, the multiple target three-dimensional key points may be determined by means of the detection result of the contact between the target part of the virtual three-dimensional model and the target contact surface of the three-dimensional space, and the multiple initial three-dimensional key points.

Still taking the adjustment of the three-dimensional pose of the human body based on Video1 as an example, the initial three-dimensional pose 3DS* may correspond to positions of the multiple three-dimensional key points of the multiple virtual human body models, which is recorded as an initial three-dimensional key point J3D. Based on the initial three-dimensional key point J3D, the multiple target three-dimensional key points may be determined by means of the detection result R{A, B, C, D}, which are recorded as J_{3D}^{target}.

At step S28, the initial three-dimensional pose is adjusted to a target three-dimensional pose by using the multiple initial three-dimensional key points and the multiple target three-dimensional key points.

The initial three-dimensional pose may be adjusted to the target three-dimensional pose based on the multiple initial three-dimensional key points and the multiple target three-dimensional key points. The initial three-dimensional key points correspond to the initial three-dimensional pose of the virtual three-dimensional model. The initial three-dimensional key points are transformed to the target three-dimensional key points according to the detection result.

Through detecting the contact between the target part of the virtual three-dimensional model and the target contact surface of the three-dimensional space, the initial three-dimensional pose of the virtual three-dimensional model is transformed to the target three-dimensional pose. Therefore, the three-dimensional pose of the virtual three-dimensional model is optimized.

Still taking the adjustment of the three-dimensional pose of the human body based on Video1 as an example, the initial three-dimensional pose 3DS* of the virtual human body model may be adjusted to the target three-dimensional pose, which is recorded as #3DS*, by means of the multiple initial three-dimensional key points J3D in each of T image frames in Video1 and the multiple target three-dimensional key points J_{3D}^{target}.

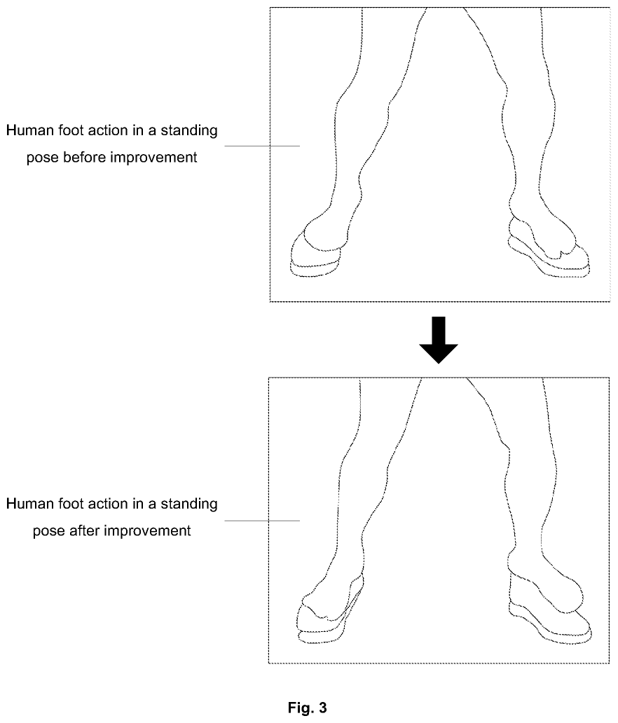

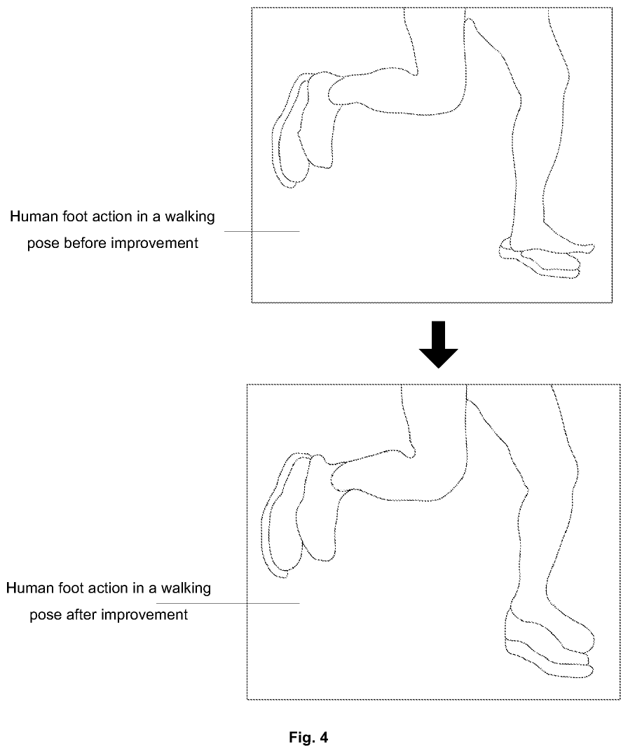

FIG. 3 is a schematic diagram showing a result of estimating a human foot action in a standing pose based on a method for adjusting a three-dimensional pose according to an optional embodiment of the present disclosure. FIG. 4 is a schematic diagram showing a result of estimating a human foot action in a walking pose based on a method for adjusting a three-dimensional pose according to an optional embodiment of the present disclosure. As shown in FIG. 3 and FIG. 4, the human foot action estimated by the algorithm before improvement corresponds to the initial three-dimensional pose 3DS* in this embodiment of the present disclosure. The human foot action estimated by the algorithm improved in this embodiment of the present disclosure corresponds to the target three-dimensional pose #3DS*. Compared with the initial three-dimensional pose 3DS*, the floating feeling of the human foot action shown by the target three-dimensional pose #3DS* is reduced and is more stable, so that the three-dimensional pose of a virtual human body is more real.

According to the method for adjusting the three-dimensional pose in this embodiment of the present disclosure, based on a given monocular video, the stable three-dimensional pose of the foot grounding action may be estimated. An application scene in this embodiment of the present disclosure includes a virtual human, human driven, augmented reality, mixed reality, and the like.

According to step S20 to step S28 in the present disclosure, the video currently recorded is acquired. The video includes the multiple image frames, and the virtual three-dimensional model is displayed in each of the multiple image frames. The multiple two-dimensional key points of the virtual three-dimensional model and the initial three-dimensional pose are estimated based on the multiple acquired image frames. Contact detection is performed on the target part of the virtual three-dimensional model by using the multiple two-dimensional key points, to obtain the detection result. The detection result is configured to indicate whether the target part is in contact with a target contact surface in three-dimensional space where the virtual three-dimensional model is located. The multiple target three-dimensional key points are determined by means of the detection result and the multiple initial three-dimensional key points corresponding to the initial three-dimensional pose. The initial three-dimensional pose is adjusted to the target three-dimensional pose by using the multiple initial three-dimensional key points and the multiple target three-dimensional key points. Therefore, a purpose of improving a monocular video-based algorithm for estimating the three-dimensional pose of a human body can be achieved, and the technical effect of enhancing the stability of human foot actions by adding grounding constraints into the monocular video-based algorithm for estimating the three-dimensional pose of the human body can be realized, thereby solving the technical problem that an algorithm does not optimize a constraint model of a human foot grounding effect, resulting inaccurate estimation of the three-dimensional pose of a human body and obvious floating feeling of a human foot action in the related art.

The above method of this embodiment is further described in detail below.

As an optional implementation, in step S22, an operation of estimating the multiple two-dimensional key points of the virtual three-dimensional model and the initial three-dimensional pose based on the multiple image frames includes the following steps.

At step S221, a target area is detected from each of the multiple image frames. The target area includes the virtual three-dimensional model.

At step S222, the target area is clipped to obtain multiple target picture blocks.

At step S223, the multiple two-dimensional key points and the initial three-dimensional pose are estimated based on the multiple target picture blocks.

The multiple image frames may be obtained by framing the video currently recorded, and each of the multiple image frames includes the virtual three-dimensional model. A process of detecting the target area from each of the multiple image frames may be to detect each image frame. Multiple pixels in the image frame that belong to the virtual three-dimensional model are marked as the target areas.

According to the target area corresponding to each of the multiple image frames, each of the multiple image frames is clipped to obtain the multiple target picture blocks. According to the multiple target picture blocks, the initial three-dimensional pose may be obtained by using an estimation algorithm. The initial three-dimensional pose may be represented by at least one initial three-dimensional pose parameter.

Still taking the adjustment of the three-dimensional pose of the human body based on Video1 as an example, the virtual human body model is displayed in each of T image frames in Video1. An area for displaying the virtual human body model is determined as the target area. Human image segmentation is performed on each of the T image frames in Video1 by using a human image segmentation model. That is, pixels in the image frame that belong to the target area are identified, and the picture block taking the virtual human body model as a center is clipped, which is recorded as Pt. Estimation is performed by using the picture block Pt, so that the multiple two-dimensional key points 2DP* and the initial three-dimensional pose 3DS* may be obtained.

Optionally, the human image segmentation model may be a Faster Region-Convolutional Neural Network (Faster R-CNN), or may also be a Mask Region-Convolutional Neural Network (Mask R-CNN) for predicting a branch of a segmented face on the basis of the Faster R-CNN.

As an optional implementation, in step S223, an operation of estimating the multiple two-dimensional key points and the initial three-dimensional pose based on the multiple target picture blocks includes the following steps.

At step S2231, a first estimation result is estimated from the multiple target picture blocks by means of a preset two-dimensional estimation manner.

At step S2232, a second estimation result is estimated from the multiple target picture blocks by means of a preset three-dimensional estimation manner.

At step S2233, the first estimation result is smoothed to obtain the multiple two-dimensional key points, and the second estimation result is smoothed to obtain the initial three-dimensional pose.

The preset two-dimensional estimation manner may estimate the first estimation result based on the multiple target picture blocks. The first estimation result may be configured to obtain the two-dimensional key points of the virtual three-dimensional model.

The preset three-dimensional estimation manner may estimate the second estimation result based on the multiple target picture blocks. The second estimation result may be configured to obtain the initial three-dimensional pose of the virtual three-dimensional model.

The first estimation result may be smoothed to obtain the multiple two-dimensional key points of the virtual three-dimensional model. The second estimation result may be smoothed to obtain the initial three-dimensional pose of the virtual three-dimensional model. The initial three-dimensional pose may be represented by the at least one initial three-dimensional pose parameter.

Still taking the adjustment of the three-dimensional pose of the human body based on Video1 as an example, by using the picture block Pt, an original two-dimensional key point, which is recorded as 2DP, of the virtual human body model is estimated based on a method of Realtime Multi-Person2D Pose Estimation using Part Affinity Fields.

By using the human picture block, an original three-dimensional pose, which is recorded as 3DS, of the virtual human body model is estimated based on a method of learning to reconstruct 3D human pose and shape via model-fitting in the Loop. Then, the original three-dimensional pose 3DS is represented as an original three-dimensional pose parameter θ by using a Skinned Multi-Person Linear Model (SMPL model).

The two-dimensional key point 2DP* may be obtained through smoothing the original two-dimensional key point 2DP of the virtual human body model. A three-dimensional pose parameter θ′ may be obtained through smoothing the original three-dimensional pose parameter θ. The three-dimensional pose parameter θ′ is configured to represent the initial three-dimensional pose. Smoothing may improve data quality of the two-dimensional key point and the three-dimensional pose parameter of the human body, thereby enhancing the accuracy of follow-up calculation.

Optionally, smoothing may be implemented by using a low-pass filter. The low-pass filter is a filtering manner, which allows a low-frequency signal to pass through, but weakens or reduces the passage of a signal of which frequency is higher than a cut-off frequency. In the field of image processing, the low-pass filter may be configured to achieve effects of image smoothing and filtering, image denoising, image enhancement, and image fusion.

As an optional implementation, in step S24, an operation of perform the contact detection on the target part by using the multiple two-dimensional key points, to obtain the detection result includes the following steps.

At step S241, the multiple two-dimensional key points are analyzed by using a preset neural network model, to obtain a detection tag of at least one two-dimensional key point corresponding to the target part. The preset neural network is obtained through training of machine learning by using multiple sets of data. Each of the multiple sets of data includes at least one two-dimensional key point carrying the detection tag. The detection tag is configured to indicate whether the at least one two-dimensional key point corresponding to the target part is in contact with the target contact surface.

The detection tag may be set as the detection result of the contact between the target part of the virtual three-dimensional model and the target contact surface in the three-dimensional space. Based on the multiple two-dimensional key points, the detection tag of the at least one two-dimensional key point corresponding to the target part of the virtual three-dimensional model is obtained by analyzing the preset neural network model.

The preset neural network model may be obtained through training of machine learning by using the multiple sets of data. Each of the multiple sets of data includes the at least one two-dimensional key point carrying the detection tag. The detection tag is configured to indicate whether the at least one two-dimensional key point corresponding to the target part is in contact with the target contact surface.

Still taking the adjustment of the three-dimensional pose of the human body based on Video1 as an example, a grounding detection neural network model is trained. The multiple two-dimensional key points 2DP* obtained by means of the T image frames in Video1 are analyzed by using the grounding detection neural network model. Then, detection tags r(A), r(B), r(C), and r(D) of the two-dimensional key points A, B, C, and D corresponding to the toes and heels of left and right feet of the virtual human body model may be obtained.

Optionally, a training process of the grounding detection neural network model includes the following. An initial neural network for training is a convolutional neural network with a three-dimensional structure. The initial neural network is trained by using a binary cross entropy loss function. Data used for training may be the multiple two-dimensional key points of the virtual human body model with a manually marked grounding tag, or may be a dataset that is composited by the multiple two-dimensional key points of the virtual human body model carrying the grounding tag.

Optionally, a process that the grounding detection neural network model analyzes the four two-dimensional key points A, B, C, and D in the nth image frame of the T image frames in Video1 includes the following steps. The nth image frame and five adjacent images before and after the nth image frame are acquired. That is, a total of 11 adjacent image frames from the n−5th image frame to the n+5th image frame are acquired, and the middle image frame of the 11 adjacent image frames is the nth image frame. The 11 adjacent image frames are inputted into the grounding detection neural network model. Foot grounding detection tags, which are recorded as r(A), r(B), r(C), and r(D), of the virtual human body model in the nth image frame are outputted through the calculation of the grounding detection neural network model.

The detection tags are configured to indicate whether the feet of the virtual human body model are in contact with the ground surface. For example, the two-dimensional key point A corresponds to the left toe of the virtual human body model, and then the detection tag r(A) indicates the probability that the left toe of the virtual human body model is in contact with the ground surface. The detection tags corresponding to the two-dimensional key points of the virtual human body model are the detection result R{A, B, C, D}.

As an optional implementation, the method for adjusting a three-dimensional pose further includes the following steps.

At step S30, initial values of the multiple initial three-dimensional key points are determined by using a first pose parameter of the initial three-dimensional pose.

The first pose parameter may be the initial three-dimensional pose parameter of the virtual three-dimensional model. By means of the first pose parameter, the initial values of the multiple initial three-dimensional key points may be determined. The initial values may be position coordinates of the initial three-dimensional key points.

Still taking the adjustment of the three-dimensional pose of the human body based on Video1 as an example, initial positions, which are recorded as J3D, of the initial three-dimensional key points of the human body may be obtained according to the initial three-dimensional pose parameter θ′. The initial positions J3D of the initial three-dimensional key points are set as the initial values of the initial three-dimensional key points.

As an optional implementation, in step S26, an operation of determining the multiple target three-dimensional key points by means of the detection result and the multiple initial three-dimensional key points includes the following steps.

At step S261, the multiple target three-dimensional key points are initialized by using the initial values of the multiple initial three-dimensional key points, to obtain initial values of the multiple target three-dimensional key points.

At step S262, a display position of at least one three-dimensional key point corresponding to the target part in each of the multiple image frames and a detection tag corresponding to each display position are acquired.

At step S263, part of three-dimensional key points is selected from the multiple target three-dimensional key points based on the detection tag corresponding to the display position. The selected part of three-dimensional key points are in contact with the target contact surface.

At step S264, an average value of display positions of the selected part of three-dimensional key points is calculated, to obtain a to-be-updated position.

At step S265, the initial values of the multiple target three-dimensional key points are updated according to the to-be-updated position, to obtain target values of the multiple target three-dimensional key points.

The initial values of the multiple initial three-dimensional key points are acquired, and the multiple target three-dimensional key points are initialized by using the initial values, so that the initial values of the multiple target three-dimensional key points may be obtained. One initialization operation may be to assign the initial value of a certain initial three-dimensional key point to the target three-dimensional key point corresponding to the initial three-dimensional key point.

The target three-dimensional key point corresponding to the target part may exist at the target part of the virtual three-dimensional model. The display position of the target three-dimensional key point in each of the multiple image frames in the video currently recorded is acquired. The display position may be represented by the position coordinate of the target three-dimensional key point in the corresponding image frame. In addition, the detection tag corresponding to the display position is acquired. The detection tag is configured to indicate whether the target three-dimensional key point corresponding to the target part in the display position is in contact with the target contact surface.

By means of the multiple detection tags corresponding to the multiple display positions, whether the multiple target three-dimensional key points are in contact with the target contact surface may be learned. Then, part of three-dimensional key points in contact with the target contact surface are selected from the multiple target three-dimensional key points, and the display positions of the part of three-dimensional key points are acquired. The display positions may be represented by the position coordinates of the part of three-dimensional key points in the corresponding image frame.

The average value of the display positions of the part of three-dimensional key points is calculated. Then the calculated average value is assigned to the target three-dimensional key point as a target value of the target three-dimensional key point. Positions corresponding to the multiple target three-dimensional key points are updated by means of the foregoing operations.

Still taking the adjustment of the three-dimensional pose of the human body based on Video1 as an example, the initial value J3D of the multiple initial three-dimensional key points are acquired. The initial value J3D of the multiple initial three-dimensional key points are assigned to the multiple corresponding target three-dimensional key points J_{3D}^{target}. That is, the multiple target three-dimensional key points J_{3D}^{target} are initialized by using the initial value J3D of the multiple initial three-dimensional key points.

The following operations are successively performed on the four two-dimensional key points A, B, C, and D on the toes and heels of the left and right feet of the virtual human body model. Three-dimensional position coordinates of the two-dimensional key points in each of the T image frames in Video1 are acquired, and the grounding detection tags of three-dimensional positions where the two-dimensional key points are located in each of the T image frames in Video1 are simultaneously acquired. Part of target three-dimensional key points in contact with the ground surface may be screened from the multiple target three-dimensional key points J_{3D}^{target}, which is recorded as J_{3D}^{target}. The average value of the corresponding position coordinates of the part of target three-dimensional key points in contact with the ground surface in each of the T image frames in Video1 is calculated, which is recorded as #J′_{3D}^{target}. The calculated average value #J_{3D}^{target} is assigned to the target three-dimensional key point. That is, the target values J_{3D}^{target} of the multiple updated target three-dimensional key points are obtained by covering the initial values of the part of target three-dimensional key points in contact with the ground surface.

As an optional implementation, in step S28, an operation of adjusting the initial three-dimensional pose to the target three-dimensional pose by using the multiple initial three-dimensional key points and the multiple target three-dimensional key points includes the following steps.

At step S281, the first pose parameter is optimized by using the initial values of the multiple initial three-dimensional key points and the target values of the multiple target three-dimensional key points, to obtain a second pose parameter.

At step S282, the initial three-dimensional pose is adjusted to the target three-dimensional pose based on the second pose parameter.

Through the initial values of the multiple initial three-dimensional key points and the target values of the multiple target three-dimensional key points, the first pose parameter may be optimized to the second pose parameter. The first pose parameter may be the initial three-dimensional pose parameter of the virtual three-dimensional model. The second pose parameter may be a target three-dimensional pose parameter of the virtual three-dimensional model. Therefore, the initial three-dimensional pose of the virtual three-dimensional model may be adjusted to the target three-dimensional pose according to the second pose parameter. That is, the three-dimensional pose optimization of the virtual three-dimensional model can be realized.

Still taking the adjustment of the three-dimensional pose of the human body based on Video1 as an example, the initial three-dimensional pose parameter θ′ may be optimized to be a target three-dimensional pose parameter θ* based on the initial values J3D of the multiple initial three-dimensional key points and the target values J_{3D}^{target} of the multiple target three-dimensional key points. A target function of the optimization process is shown as the following formula (1).

$${θ}^{*} = {min}_{{θ}^{′}} ( {‖ {J}_{3 D} ( {θ}^{′} ) - {J}_{3 D}^{target} ‖}_{2} ) \qquad Formula ( 1 )$$

According to the optimized target three-dimensional pose parameter, poses of the toes and heels of the left and right feet of the virtual human body model may be adjusted and optimized, so that the jittering of finally shown step actions of the virtual human body model is reduced, and a floating feeling is alleviated, thereby causing the three-dimensional pose of the human body estimated based on Video1 to be more real.

In particular, the optimization method used by the optimization process may be A Method For Stochastic Optimization (ADAM) or a limited-memory BFGS method. The BFGS method is studied by C. G. Broyden, R. Fletcher, D. Goldfarb, and D. F. Shanno, hence its name.

From the above descriptions about the implementation modes, those skilled in the art may clearly know that the method according to the foregoing embodiments may be implemented in a manner of combining software and a necessary universal hardware platform, and of course, may also be implemented through hardware, but the former is an optional implementation mode under many circumstances. Based on such an understanding, the technical solutions of the present disclosure substantially or parts making contributions to the conventional art may be embodied in form of a software product, and the computer software product is stored in a storage medium, including multiple instructions for causing a terminal device (which may be a mobile phone, a computer, a server, a network device or the like) to execute the method in each embodiment of the present disclosure.

The present disclosure further provides an apparatus for adjusting a three-dimensional pose. The apparatus is configured to implement the foregoing embodiments and the preferred implementation, and what has been described will not be described again. As used below, the term “module” may be a combination of software and/or hardware that implements a predetermined function. Although the apparatus described in the following embodiments is exemplary implemented in software, but implementations in hardware, or a combination of software and hardware, are also possible and conceived.

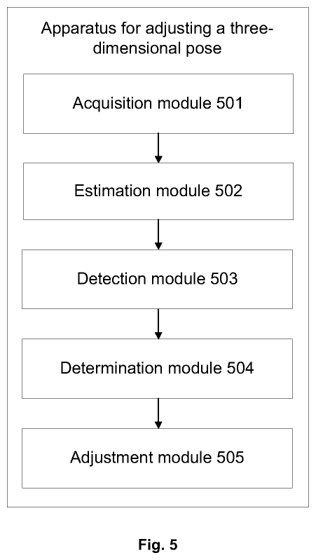

FIG. 5 is a structural block diagram of an apparatus for adjusting a three-dimensional pose according to an embodiment of the present disclosure. As shown in FIG. 5, the apparatus 500 for adjusting a three-dimensional pose includes an acquisition module 501, an estimation module 502, a detection module 503, a determination module 504, and an adjustment module 505.

The acquisition module 501 is configured to acquire a video currently recorded. The video includes multiple image frames, and a virtual three-dimensional model is displayed in each of the multiple image frames. The estimation module 502 is configured to estimate multiple two-dimensional key points of a virtual three-dimensional model and an initial three-dimensional pose based on multiple image frames. The detection module 503 is configured to perform contact detection on a target part of the virtual three-dimensional model by using the multiple two-dimensional key points, to obtain a detection result. The detection result is configured to indicate whether the target part is in contact with a target contact surface in three-dimensional space where the virtual three-dimensional model is located. The determination module 504 is configured to determine multiple target three-dimensional key points by means of the detection result and multiple initial three-dimensional key points corresponding to the initial three-dimensional pose. The adjustment module 505 is configured to adjust the initial three-dimensional pose to a target three-dimensional pose by using the multiple initial three-dimensional key points and the multiple target three-dimensional key points.

Optionally, the estimation module 502 is further configured to: detect a target area from each of the multiple image frames, where the target area includes the virtual three-dimensional model; clip the target area to obtain multiple target picture blocks; and estimate the multiple two-dimensional key points and the initial three-dimensional pose based on the multiple target picture blocks.

Optionally, the estimation module 502 is further configured to: estimate a first estimation result from the multiple target picture blocks by means of a preset two-dimensional estimation manner; estimate a second estimation result from the multiple target picture blocks by means of a preset three-dimensional estimation manner; and smooth the first estimation result to obtain the multiple two-dimensional key points, and smooth the second estimation result to obtain the initial three-dimensional pose.

Optionally, the detection module 503 is further configured to: analyze the multiple two-dimensional key points by using a preset neural network model, to obtain a detection tag of at least one two-dimensional key point corresponding to the target part. The preset neural network is obtained through training of machine learning by using multiple sets of data. Each of the multiple sets of data includes at least one two-dimensional key point carrying the detection tag. The detection tag is configured to indicate whether the at least one two-dimensional key point corresponding to the target part is in contact with the target contact surface.

Optionally, the apparatus 500 for adjusting a three-dimensional pose further includes an initialization module 506 (not shown in the figure), configured to determine initial values of the multiple initial three-dimensional key points by using a first pose parameter of the initial three-dimensional pose.

Optionally, the determination module 504 is further configured to: initialize the multiple target three-dimensional key points by using the initial values of the multiple initial three-dimensional key points, to obtain initial values of the multiple target three-dimensional key points; acquire a display position of at least one three-dimensional key point corresponding to the target part in each of the multiple image frames and a detection tag corresponding to each display position; select part of three-dimensional key points from the multiple target three-dimensional key points based on the detection tag corresponding to the display position, where the selected part of three-dimensional key points are in contact with the target contact surface; calculate an average value of the display positions of the selected part of three-dimensional key points, to obtain a to-be-updated position; and update the initial values of the multiple target three-dimensional key points according to the to-be-updated position, to obtain target values of the multiple target three-dimensional key points.

Optionally, the adjustment module 505 is further configured to: optimize the first pose parameter by using the initial values of the multiple initial three-dimensional key points and the target values of the multiple target three-dimensional key points, to obtain a second pose parameter; and adjust the initial three-dimensional pose to the target three-dimensional pose based on the second pose parameter.

It is to be noted that, each of the above modules may be implemented by software or hardware. For the latter, it may be implemented in the following manners, but is not limited to the follow: the above modules are all located in a same processor; or the above modules are located in different processors in any combination.

An embodiment of the present disclosure further provides an electronic device. The electronic device includes a memory and at least one processor. The memory is configured to store at least one computer instruction. The processor is configured to run the at least one computer instruction to perform steps in any one of method embodiments described above.

Optionally, the electronic device may further include a transmission device and an input/output device. The transmission device is connected with the processor. The input/output device is connected with the processor.

Optionally, in this embodiment, the processor may be configured to perform the following steps through the computer program.

At step S1, a video currently recorded is acquired. The video includes multiple image frames, and a virtual three-dimensional model is displayed in each of the multiple image frames.

At step S2, multiple two-dimensional key points of the virtual three-dimensional model and an initial three-dimensional pose are estimated based on the multiple image frames.

At step S3, contact detection is performed on a target part of the virtual three-dimensional model by using the multiple two-dimensional key points, to obtain a detection result. The detection result is configured to indicate whether the target part is in contact with a target contact surface in three-dimensional space where the virtual three-dimensional model is located.

At step S4, multiple target three-dimensional key points are determined by means of the detection result and multiple initial three-dimensional key points corresponding to the initial three-dimensional pose.

At step S5, the initial three-dimensional pose is adjusted to a target three-dimensional pose by using the multiple initial three-dimensional key points and the multiple target three-dimensional key points.

Optionally, for specific examples in this embodiment, refer to the examples described in the foregoing embodiments and the optional implementations, and this embodiment will not be repeated thereto.

An embodiment of the present disclosure further provides a non-transitory computer-readable storage medium storing at least one computer instruction. The non-transitory computer-readable storage medium stores at least one computer instruction. Steps in any one of the method embodiments described above are performed when the at least one computer instruction is run.

Optionally, in this embodiment, the non-transitory computer-readable storage medium may be configured to store a computer program for performing the following steps.

At step S1, a video currently recorded is acquired. The video includes multiple image frames, and a virtual three-dimensional model is displayed in each of the multiple image frames.

At step S2, multiple two-dimensional key points of the virtual three-dimensional model and an initial three-dimensional pose are estimated based on the multiple image frames.

At step S3, contact detection is performed on a target part of the virtual three-dimensional model by using the multiple two-dimensional key points, to obtain a detection result. The detection result is configured to indicate whether the target part is in contact with a target contact surface in three-dimensional space where the virtual three-dimensional model is located.

At step S4, multiple target three-dimensional key points are determined by means of the detection result and multiple initial three-dimensional key points corresponding to the initial three-dimensional pose.

At step S5, the initial three-dimensional pose is adjusted to a target three-dimensional pose by using the multiple initial three-dimensional key points and the multiple target three-dimensional key points.

Optionally, in this embodiment, the non-transitory computer-readable storage medium may include, but is not limited to, a USB flash disk, a Read-Only Memory (ROM), a Random Access Memory (RAM), and various media that can store computer programs, such as a mobile hard disk, a magnetic disk, or an optical disk.

An embodiment of the present disclosure further provides a computer program product. Program codes used for implementing the method for adjusting a three-dimensional pose of the present disclosure can be written in any combination of at least one programming language. These program codes can be provided to the processors or controllers of general computers, special computers, or other programmable data processing devices, so that, when the program codes are performed by the processors or controllers, functions/operations specified in the flowcharts and/or block diagrams are implemented. The program codes can be performed entirely on a machine, partially performed on the machine, and partially performed on the machine and partially performed on a remote machine as an independent software package, or entirely performed on the remote machine or a server.

The serial numbers of the foregoing embodiments of the present disclosure are for description, and do not represent the superiority or inferiority of the embodiments.

In the above embodiments of the present disclosure, the description of the embodiments has its own focus. For parts that are not described in detail in a certain embodiment, reference may be made to related descriptions of other embodiments.

In the several embodiments provided in the present disclosure, it should be understood that, the disclosed technical content can be implemented in other ways. The apparatus embodiments described above are illustrative. For example, the division of the units may be a logical function division, and there may be other divisions in actual implementation. For example, multiple units or components may be combined or integrated into another system, or some features can be ignored, or not implemented. In addition, the displayed or discussed mutual coupling or direct coupling or communication connection may be indirect coupling or communication connection through some interfaces, units or modules, and may be in electrical or other forms.

The units described as separate components may or may not be physically separated. The components displayed as units may or may not be physical units, that is, the components may be located in one place, or may be distributed on the multiple units. Part or all of the units may be selected according to actual requirements to achieve the purposes of the solutions of this embodiment.

In addition, the functional units in the various embodiments of the present disclosure may be integrated into one processing unit, or each unit may exist alone physically, or at least two units may be integrated into one unit. The above integrated unit can be implemented in the form of hardware, or can be implemented in the form of a software functional unit.

If the integrated unit is implemented in the form of the software functional unit and sold or used as an independent product, it can be stored in the computer readable storage medium. Based on this understanding, the technical solutions of the present disclosure essentially or the parts that contribute to the related art, or all or part of the technical solutions can be embodied in the form of a software product. The computer software product is stored in a storage medium, including multiple instructions for causing a computer device (which may be a personal computer, a server, or a network device, and the like) to execute all or part of the steps of the method described in the various embodiments of the present disclosure. The foregoing storage medium includes a USB flash disk, a Read-Only Memory (ROM), a Random Access Memory (RAM), and various media that can store program codes, such as a mobile hard disk, a magnetic disk, or an optical disk.

The above description are exemplary implementations of the present disclosure, and it should be noted that persons of ordinary skill in the art may also make several improvements and refinements without departing from the principle of the present disclosure, and it should be considered that these improvements and refinements shall all fall within the protection scope of the present disclosure.

What is claimed is:

1. A method for adjusting a three-dimensional pose, comprising:
acquiring a video currently recorded, wherein the video comprises a plurality of image frames, and a virtual three-dimensional model is displayed in each of the plurality of image frames;
estimating a plurality of two-dimensional key points of the virtual three-dimensional model and an initial three-dimensional pose based on the plurality of image frames;
performing contact detection on a target part of the virtual three-dimensional model by using the plurality of two-dimensional key points, to obtain a detection result, wherein the detection result is configured to indicate whether the target part is in contact with a target contact surface in three-dimensional space where the virtual three-dimensional model is located;
determining a plurality of target three-dimensional key points by means of the detection result and a plurality of initial three-dimensional key points corresponding to the initial three-dimensional pose; and
adjusting the initial three-dimensional pose to a target three-dimensional pose by using the plurality of initial three-dimensional key points and the plurality of target three-dimensional key points.

2. The method as claimed in claim 1, wherein estimating the plurality of two-dimensional key points and the initial three-dimensional pose based on the plurality of image frames comprises:
detecting a target area from each of the plurality of image frames, wherein the target area comprises the virtual three-dimensional model;
clipping the target area to obtain a plurality of target picture blocks; and
estimating the plurality of two-dimensional key points and the initial three-dimensional pose based on the plurality of target picture blocks.

3. The method as claimed in claim 2, wherein estimating the plurality of two-dimensional key points and the initial three-dimensional pose based on the plurality of target picture blocks comprises:
estimating a first estimation result from the plurality of target picture blocks by means of a preset two-dimensional estimation manner;
estimating a second estimation result from the plurality of target picture blocks by means of a preset three-dimensional estimation manner; and
smoothing the first estimation result to obtain the plurality of two-dimensional key points, and smoothing the second estimation result to obtain the initial three-dimensional pose.

4. The method as claimed in claim 1, wherein performing the contact detection on the target part by using the plurality of two-dimensional key points, to obtain the detection result comprises:
analyzing the plurality of two-dimensional key points by using a preset neural network model, to obtain a detection tag of at least one two-dimensional key point corresponding to the target part, wherein the preset neural network is obtained through training of machine learning by using a plurality of sets of data; each of the plurality of sets of data comprises at least one two-dimensional key point carrying the detection tag; and the detection tag is configured to indicate whether the at least one two-dimensional key point corresponding to the target part is in contact with the target contact surface.

5. The method as claimed in claim 4, further comprising:
determining initial values of the plurality of initial three-dimensional key points by using a first pose parameter of the initial three-dimensional pose.

6. The method as claimed in claim 5, wherein determining the plurality of target three-dimensional key points by means of the detection result and the plurality of initial three-dimensional key points comprises:
initializing the plurality of target three-dimensional key points by using the initial values of the plurality of initial three-dimensional key points, to obtain initial values of the plurality of target three-dimensional key points;
acquiring a display position of at least one three-dimensional key point corresponding to the target part in each of the plurality of image frames and a detection tag corresponding to each display position;
selecting part of three-dimensional key points from the plurality of target three-dimensional key points based on the detection tag corresponding to the display position, wherein the selected part of three-dimensional key points are in contact with the target contact surface;
calculating an average value of display positions of the selected part of three-dimensional key points, to obtain a to-be-updated position; and
updating the initial values of the plurality of target three-dimensional key points according to the to-be-updated position, to obtain target values of the plurality of target three-dimensional key points.

7. The method as claimed in claim 6, wherein adjusting the initial three-dimensional pose to the target three-dimensional pose by using the plurality of initial three-dimensional key points and the plurality of target three-dimensional key points comprises:
optimizing the first pose parameter by using the initial values of the plurality of initial three-dimensional key points and the target values of the plurality of target three-dimensional key points, to obtain a second pose parameter; and
adjusting the initial three-dimensional pose to the target three-dimensional pose based on the second pose parameter.

8. An electronic device, comprising:
at least one processor, and
a memory, communicatively connected with the at least one processor, wherein
the memory is configured to store at least one instruction executable by the at least one processor, and the at least one instruction is performed by the at least one processor, to cause the at least one processor to perform the following steps:
acquiring a video currently recorded, wherein the video comprises a plurality of image frames, and a virtual three-dimensional model is displayed in each of the plurality of image frames;
estimating a plurality of two-dimensional key points of the virtual three-dimensional model and an initial three-dimensional pose based on the plurality of image frames;
performing contact detection on a target part of the virtual three-dimensional model by using the plurality of two-dimensional key points, to obtain a detection result, wherein the detection result is configured to indicate whether the target part is in contact with a target contact surface in three-dimensional space where the virtual three-dimensional model is located;
determining a plurality of target three-dimensional key points by means of the detection result and a plurality of initial three-dimensional key points corresponding to the initial three-dimensional pose; and
adjusting the initial three-dimensional pose to a target three-dimensional pose by using the plurality of initial three-dimensional key points and the plurality of target three-dimensional key points.

9. The electronic device as claimed in claim 8, wherein estimating the plurality of two-dimensional key points and the initial three-dimensional pose based on the plurality of image frames comprises:
detecting a target area from each of the plurality of image frames, wherein the target area comprises the virtual three-dimensional model;
clipping the target area to obtain a plurality of target picture blocks; and
estimating the plurality of two-dimensional key points and the initial three-dimensional pose based on the plurality of target picture blocks.

10. The electronic device as claimed in claim 9, wherein estimating the plurality of two-dimensional key points and the initial three-dimensional pose based on the plurality of target picture blocks comprises:
estimating a first estimation result from the plurality of target picture blocks by means of a preset two-dimensional estimation manner;
estimating a second estimation result from the plurality of target picture blocks by means of a preset three-dimensional estimation manner; and
smoothing the first estimation result to obtain the plurality of two-dimensional key points, and smoothing the second estimation result to obtain the initial three-dimensional pose.

11. The electronic device as claimed in claim 8, wherein performing the contact detection on the target part by using the plurality of two-dimensional key points, to obtain the detection result comprises:
analyzing the plurality of two-dimensional key points by using a preset neural network model, to obtain a detection tag of at least one two-dimensional key point corresponding to the target part, wherein the preset neural network is obtained through training of machine learning by using a plurality of sets of data; each of the plurality of sets of data comprises at least one two-dimensional key point carrying the detection tag; and the detection tag is configured to indicate whether the at least one two-dimensional key point corresponding to the target part is in contact with the target contact surface.

12. The electronic device as claimed in claim 11, further comprising:
determining initial values of the plurality of initial three-dimensional key points by using a first pose parameter of the initial three-dimensional pose.

13. The electronic device as claimed in claim 12, wherein determining the plurality of target three-dimensional key points by means of the detection result and the plurality of initial three-dimensional key points comprises:
initializing the plurality of target three-dimensional key points by using the initial values of the plurality of initial three-dimensional key points, to obtain initial values of the plurality of target three-dimensional key points;
acquiring a display position of at least one three-dimensional key point corresponding to the target part in each of the plurality of image frames and a detection tag corresponding to each display position;
selecting part of three-dimensional key points from the plurality of target three-dimensional key points based on the detection tag corresponding to the display position, wherein the selected part of three-dimensional key points are in contact with the target contact surface;
calculating an average value of display positions of the selected part of three-dimensional key points, to obtain a to-be-updated position; and
updating the initial values of the plurality of target three-dimensional key points according to the to-be-updated position, to obtain target values of the plurality of target three-dimensional key points.

14. The electronic device as claimed in claim 13, wherein adjusting the initial three-dimensional pose to the target three-dimensional pose by using the plurality of initial three-dimensional key points and the plurality of target three-dimensional key points comprises:
optimizing the first pose parameter by using the initial values of the plurality of initial three-dimensional key points and the target values of the plurality of target three-dimensional key points, to obtain a second pose parameter; and
adjusting the initial three-dimensional pose to the target three-dimensional pose based on the second pose parameter.

15. A non-transitory computer readable storage medium, storing at least one computer instruction, wherein the at least one computer instruction is used for a computer to perform the following steps:
acquiring a video currently recorded, wherein the video comprises a plurality of image frames, and a virtual three-dimensional model is displayed in each of the plurality of image frames;
estimating a plurality of two-dimensional key points of the virtual three-dimensional model and an initial three-dimensional pose based on the plurality of image frames;
performing contact detection on a target part of the virtual three-dimensional model by using the plurality of two-dimensional key points, to obtain a detection result, wherein the detection result is configured to indicate whether the target part is in contact with a target contact surface in three-dimensional space where the virtual three-dimensional model is located;
determining a plurality of target three-dimensional key points by means of the detection result and a plurality of initial three-dimensional key points corresponding to the initial three-dimensional pose; and
adjusting the initial three-dimensional pose to a target three-dimensional pose by using the plurality of initial three-dimensional key points and the plurality of target three-dimensional key points.

16. The non-transitory computer readable storage medium as claimed in claim 15, wherein estimating the plurality of two-dimensional key points and the initial three-dimensional pose based on the plurality of image frames comprises:
detecting a target area from each of the plurality of image frames, wherein the target area comprises the virtual three-dimensional model;
clipping the target area to obtain a plurality of target picture blocks; and
estimating the plurality of two-dimensional key points and the initial three-dimensional pose based on the plurality of target picture blocks.

17. The non-transitory computer readable storage medium as claimed in claim 16, wherein estimating the plurality of two-dimensional key points and the initial three-dimensional pose based on the plurality of target picture blocks comprises:
estimating a first estimation result from the plurality of target picture blocks by means of a preset two-dimensional estimation manner;
estimating a second estimation result from the plurality of target picture blocks by means of a preset three-dimensional estimation manner; and
smoothing the first estimation result to obtain the plurality of two-dimensional key points, and smoothing the second estimation result to obtain the initial three-dimensional pose.

18. The non-transitory computer readable storage medium as claimed in claim 15, wherein performing the contact detection on the target part by using the plurality of two-dimensional key points, to obtain the detection result comprises:
analyzing the plurality of two-dimensional key points by using a preset neural network model, to obtain a detection tag of at least one two-dimensional key point corresponding to the target part, wherein the preset neural network is obtained through training of machine learning by using a plurality of sets of data; each of the plurality of sets of data comprises at least one two-dimensional key point carrying the detection tag; and the detection tag is configured to indicate whether the at least one two-dimensional key point corresponding to the target part is in contact with the target contact surface.

19. The non-transitory computer readable storage medium as claimed in claim 18, further comprising:
determining initial values of the plurality of initial three-dimensional key points by using a first pose parameter of the initial three-dimensional pose.

20. The non-transitory computer readable storage medium as claimed in claim 19, wherein determining the plurality of target three-dimensional key points by means of the detection result and the plurality of initial three-dimensional key points comprises:
initializing the plurality of target three-dimensional key points by using the initial values of the plurality of initial three-dimensional key points, to obtain initial values of the plurality of target three-dimensional key points;
acquiring a display position of at least one three-dimensional key point corresponding to the target part in each of the plurality of image frames and a detection tag corresponding to each display position;
selecting part of three-dimensional key points from the plurality of target three-dimensional key points based on the detection tag corresponding to the display position, wherein the selected part of three-dimensional key points are in contact with the target contact surface;
calculating an average value of display positions of the selected part of three-dimensional key points, to obtain a to-be-updated position; and
updating the initial values of the plurality of target three-dimensional key points according to the to-be-updated position, to obtain target values of the plurality of target three-dimensional key points.
